(19) United States
(12) Patent Application Publication
(10) Pub. No.: US 2009/0011101 A1
(43) Pub. Date: Jan. 8, 2009

(54) COOKING METHODS FOR A COMBI OVEN

(75) Inventors: James E. Doherty, Glenview, IL (US); Michel Foray, Passenans (FR); Gerard Beausse, Charenton (FR)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 12/281,334

(22) PCT Filed: Mar. 7, 2007
(86) PCT No.: PCT/US07/63449

§ 371 Date: Sep. 2, 2008

Related U.S. Application Data
(60) Provisional application No. 60/780,425, filed on Mar. 8, 2006.

(51) Int. Cl. H05B 6/68; A23L 1/01; G05D 23/30

(52) U.S. Cl. 426/523; 219/680; 219/702

(57) ABSTRACT

A combination oven includes convection, steam and microwave cooking sources. When implementing a user selected cooking program using the microwave source and at least one of the other sources, the oven control is configured to implement the cooking program in a manner using an input food product mass value to set microwave energy level applied to the food product during operation of the cooking program and without changing cook time as set by the cooking program. The microwave energy level may be set such that end product achieved without changing cook time has a comparable degree of doneness regardless of mass. The oven control, or a separate computerized device, may be used to automatically convert a non-microwave cooking program into a microwave enhanced cooking program that is stored by the oven control for selection by an operator. Where a collective power consumption capability of the convection heat cooking source, steam cooking source and microwave energy cooking source is higher than rated power available from a power source of the combination oven, the oven control implements power sharing rules.

### CROSS-REFERENCES

This application claims the benefit of U.S. provisional application Ser. No. 60/780,425, filed Mar. 8, 2006.

### TECHNICAL FIELD

This application relates generally to combination ovens that utilize multiple cooking technologies (e.g., radiant, convection, steam, microwave) to transfer heat to food products, and more particularly, to a combination oven that evaluates user input information and defines a cooking methodology and time based upon food product parameters.

### BACKGROUND

Foodstuffs are cooked traditionally by applying thermal energy for a given time. In conventional ovens, foodstuffs are cooked by heat radiated from the oven cavity walls or by a nearby heat source to the surface of the foodstuff. In convection ovens, heat energy is transferred to the surface of foodstuffs by convection from heated air moving though the oven cavity and over the surface of the foodstuff. In microwave ovens heat is transferred by absorption of microwave energy directly into the mass of foodstuffs. In steamers heat is transferred by steam condensing on the surface of the foodstuff.

In combination ovens more than one heat transfer process is used for the purpose of decreasing cooking time or to improve the taste, texture, moisture content or the visual, appeal of the cooked foodstuff. In the usual single energy source case, cooking time for a foodstuff is based on empirically established time-temperature relationships; these time-temperature cycles are developed specifically for each recipe. Cooking success depends upon strict adherence to the recipe or else a method of food sampling must be used near the end of an estimated cooking time to assure that the desired cooking stage has been reached.

One improvement on the strict recipe approach has been the advent of internal temperature probe systems that measure internal temperatures. As good as these devices are, they only measure at a point and the point must be chosen carefully if the desired cooking results are to be achieved. Even here the foodstuffs are often sampled to assure that the desired cooking result has been achieved.

Recently a new triple combination oven, which includes convection, steam and microwave energy sources has been developed. This new triple oven offers the potential for shorter cooking times and improved texture, moisture and visual appeal of foodstuff in comparison with single or even double heat source ovens. As triple ovens are new, optimum cooking methodologies have not been developed, and each chef must adapt and convert his existing recipes and cooking procedures to the new ovens recipe by recipe; a tedious task at best. In addition, the new ovens do not have automated controls based on kitchen friendly parameters, such as food type and weight, requiring chefs to spend considerable time in creating new cooking processes for the kitchen.

### SUMMARY

In one aspect, a method of cooking a food product using a combination oven including a microwave source for cooking and at least one non-microwave cooking source is provided. The oven includes a user selectable cooking program for the food product, where the cooking operation implemented by the user selectable cooking program uses both the microwave source and the non-microwave source. The method involves: identifying a food product mass value that does not exceed capacity of the oven for the food product to be cooked during operation of the cooking program; and carrying out the cooking operation according to the user selectable cooking program, including: utilizing the food product mass value to set microwave energy level applied to the food product during operation of the cooking program and without changing cook time as set by the cooking program.

In another aspect, a method of using a combination oven that includes a microwave source for cooking, a steam source for cooking and a convection source for cooking is provided. The oven includes a control for controlling cooking operations. The method involves: the control receiving a non-microwave cooking program for a food product, the non-microwave cooking program utilizing at least one of steam or convection; the control automatically converting the non-microwave cooking program to a microwave enhanced cooking program that uses microwaves in addition to at least one of steam or convection; and the control storing the microwave enhanced cooking program for later selection and use.

In a further aspect, a method of setting up a combination oven that includes a microwave source for cooking, a steam source for cooking and a convection source for cooking is provided. The oven includes a control for controlling cooking operations. The method involves: uploading a non-microwave cooking program for a food product to a computer device separate from the combination oven, the non-microwave cooking program utilizing at least one of steam or convection; the computer device automatically converting the non-microwave cooking program to a microwave enhanced cooking program that uses microwaves in addition to at least one of steam or convection; transmitting the microwave enhanced cooking program from the computer device to the control of the combination oven; and storing the microwave enhanced cooking program in the control of the combination oven for later selection and use.

In yet another aspect, a method of controlling power sharing in a combination oven is provided where the combination oven includes each of a convection heat cooking source, a steam cooking source and a microwave energy cooking source. A collective power consumption capability of the convection heat cooking source, steam cooking source and microwave energy cooking source is higher than rated power available from a power source of the combination oven. The method involves the steps of: (a) if individual power called for from any one of the cooking sources needed to cook a mass of food product according to a cooking program is greater than the power capacity of the cooking source, utilize the power capacity of such cooking source to evaluate any need for power sharing; and (b) if total power needed to cook the mass of food product using multiple cooking sources simultaneously in accordance with the cooking program, taking into account any adjustments per step (a), exceeds the rated power available from the power source, reduce the power to be delivered to the cooking source that has the lowest specific power absorption rate to the food product until total power demand of the multiple cooking sources is equal to or below the rated power available from the power source.

In a further aspect, a method of controlling a cooking operation in a combination oven is provided where the oven includes each of a convection heat cooking source, a steam cooking source and a microwave energy cooking source. A collective power consumption capability of the convection heat cooking source, steam cooking source and microwave energy cooking source is higher than rated power available from a power source of the combination oven. The method involves the steps of: if individual power called for from any one of the cooking sources needed to cook a mass of food product according to a cooking program having a set cooking time is greater than the power capacity of the cooking source, utilize the power capacity of such cooking source to determine an extended cooking time needed.

### BRIEF DESCRIPTION OF DRAWINGS

FIG. 1 is graph showing microwave power absorbed vs. depth;

FIG. 2 is a bar graph showing exemplary surface areas per unit weight for various food product types;

FIG. 3 is a table summarizing certain exemplary cooking algorithms;

FIG. 4 is a schematic depiction of a combination oven including convection, steam and microwave sources; and

FIG. 5 is a schematic depiction of a control system of the oven of FIG. 4.

### DETAILED DESCRIPTION

To overcome earlier deficiencies, a range of cooking algorithms for triple-energy source combination ovens using convection, steam and microwave energy have been developed. These algorithms are used as the bases for oven control systems that use kitchen friendly terms such as foodstuff type, weight, size and quantity for controlling the oven. These control algorithms were developed using theoretical and empirical experience and are effective over a range of practical operation conditions for typical oven designs.

The algorithms cover oven cavity sizes from 0.1 cubic meters to 1.2 cubic meters with internal cavity single edge dimensions ranging from 500 mm to 2000 mm, oven input power ranging from 6 kW to 60 kW, forced air movement velocities from near zero to 500 cm/sec, steam dew point from lowest possible, a vented oven, to condensing, and microwave input energy from 2.4 kW to 16 kW input power.

The following technical foundation supports the algorithms that have been developed.

### Technical Background

JI\check{R}INA HOU\check{S}OVA and KAREL HOKE of the Food Research Institute Prague, Czech Republic, have presented data to show that the energy absorbed by water in a microwave oven is distributed equally to all the water in the oven; Czech J. Food Sci. Vol. 20, No. 3: 117-124. In practice this means that time to reach a given temperature using microwave energy will double if the amount of foodstuff is doubled when the energy input to the oven remains the same.

From electromagnetic theory, power absorbed in a thick dielectric medium depends on the depth. A quantity called the absorption skin depth can be defined to generally describe this phenomenon; at this depth the power has been reduced by a factor of 1/e or roughly to 37% of its initial value. The absorption skin depth, ASD, is given by the expression:

$$ASD = \frac{λ}{( 2 π * sqrt ( ε ) * tan δ )} , \qquad Eq . 1$$

where λ is the wavelength, E is the dielectric constant and tan δ is the loss tangent.

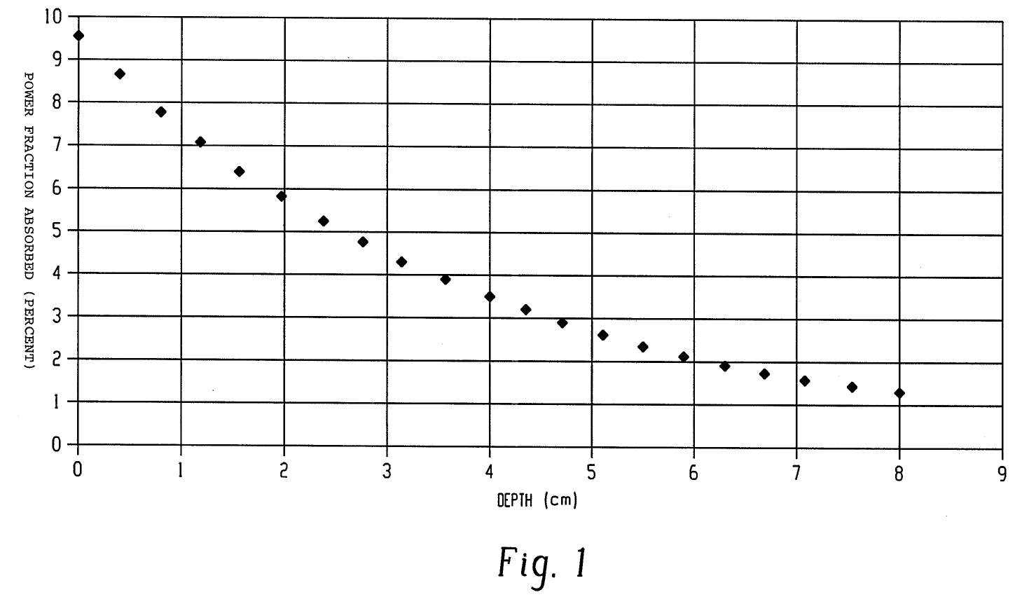

At 3 GHz, the microwave oven frequency, the dielectric constant for water is 76.7 and the loss tangent is 0.057. Given that the wavelength at microwave oven frequencies is approximately 12 cm, the absorption skin depth for water is about 3.8 cm. Practically this means that roughly 65% of the energy is absorbed the first 3.8 cm of thick foodstuff. Of course foodstuff are not 100% water but they are of a large percentage of water, typically 85%, such that a working practical absorption skin depth is 4 cm. FIG. 1 can be used to determine the fraction of energy absorbed in each individual layer of a dense foodstuff.

The thermal conductivity of water is 0.6 W/m.° C. and that of many foodstuffs is somewhat less than this quantity and typically about 0.5 W/m.° C. The heat capacity of water is 4.2 J/° C.m3. Frozen food has different properties from unfrozen food. For some foodstuffs the thermal conductivity of frozen foods can be as high as three times as great as for unfrozen food, typically about 1.5 W/m.° C.; for other porous foodstuffs the thermal conductivity of frozen materials is slightly less than unfrozen material. The transformation from frozen to unfrozen food is energy intensive because of the latent heat of freezing, which is 335 kJ/kg.

From analysis and empirical studies, heat is transferred to foodstuff in a convection oven at a rate of 2 to 8 kJ/sec·m2 depending on the shape of the foodstuff and the utensil used. As typical foods have a surface area per weight of 0.02 (e.g., a small rib roast), to 0.15 m2/kg (e.g., a chicken leg). The effective convection heating rate for a typical convection oven at 200° C. is about 120 J/kg/sec for items having a surface area per weight of about 0.06 m2/kg.

From analysis and empirical studies, the heat transfer rate to foodstuff in a steam oven is about 5 kJ/sec·m2. With a surface area for foods typically steamed ranging from 0.12 (e.g., small potatoes), to 1.5 m2/kg (e.g., small peas), the typical average steam heat rate is about 140 J/kg/sec for larger dense vegetables like potatoes and about 420 J/Kg/sec for smaller porous vegetables like green beans.

In general the performance for a particular oven, either convection mode or steam mode, depends on the power capacity of the oven. If the oven power capacity is not high enough then it will not be possible to achieve the above heating rates if overly large amounts of foodstuffs are put in the oven; this will be particularly true for high surface area per kilogram foodstuffs like peas or green beans being heated by steam.

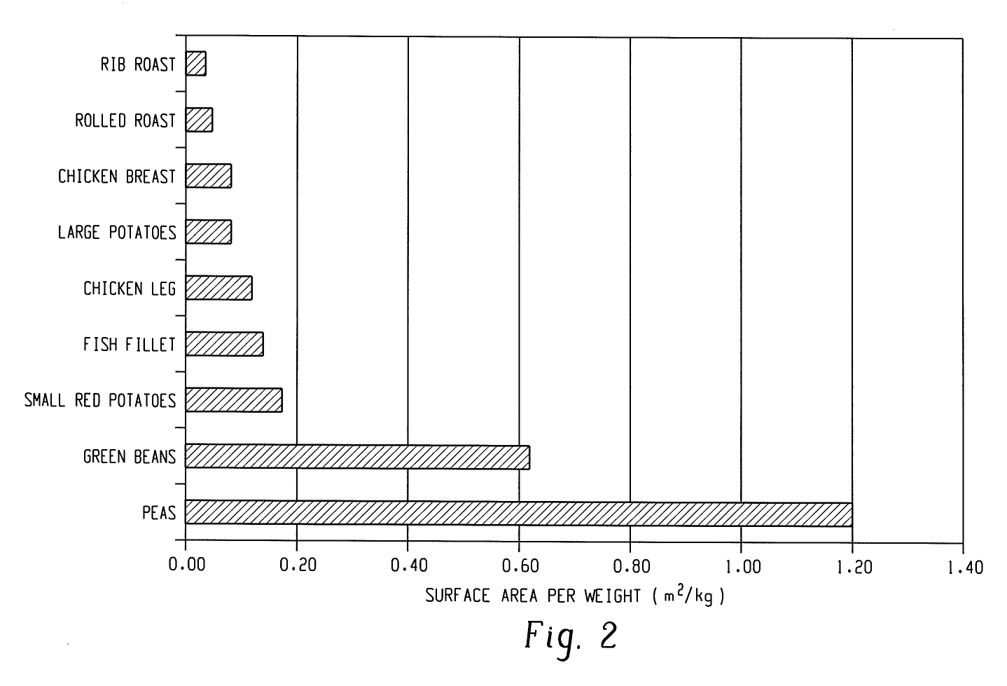

Although it is technically more natural to think of convection and steam heating processes in terms of foodstuff surface area, this is not the natural measuring unit in the kitchen; weight is much more convenient there. Appropriately the most useful algorithms will be based on foodstuff weight. Therefore it is important to classify foodstuff-cooking parameters in terms of their weight. The chart of FIG. 2 shows some typical cases. The most variation in surface area per weight occurs for small items in particular, vegetables. For items that are roasted or baked it is possible to select and apply a standard surface area per weight that is suitable for large classes of foodstuffs. At first the broad generalization of using surface area per weight might seem to be a gross method of classifying cooking performance, but in fact it is not so. Maintaining consistent shape and size is a routine part of portion control and managing cooking constancy in all commercial kitchens.

The following general format of an exemplary basic cooking algorithm is:

1) (enter foodstuff type or class).

2) (enter foodstuff load weight).

3) (enter final condition).

4) (lookup parameters)

5) (auto set humidity condition)

6) (auto set fill factor)

7) (auto set thermal condition)

8) (auto set microwave condition)

9) (auto set cooking time)

10) (start cooking cycle)

11) (signal end of cooking)

Another general form of the cooking algorithm extends the basic algorithm to cases where a class of foodstuffs requires a series of cooking cycles to complete:

1) (enter foodstuff type or class).

2) (enter foodstuff load weight).

3) (enter final condition).

4) (lookup parameters)

5) (auto set humidity condition 1)

6) (auto set fill factor 1)

7) (auto set microwave condition 1)

8) (auto set thermal condition 1)

9) (auto set cooking time 1)

10) (start cooking sub-cycle 1)

11) (auto set humidity condition 2)

12) (auto set fill factor 2)

13) (auto set thermal condition 2)

14) (auto set microwave condition 2)

15) (auto set cooking time 2)

16) (start cooking sub-cycle 2)

17) etc.

18) (signal end of cooking)

In the above (final condition) would be for red meat either final internal temperature or a condition like rare or well done; or for a vegetable it would be something like firm or soft.

In the above look up parameters means—recall parameters for a specific food stuff—and then the subsequent step set parameters means—use the parameters to calculate oven parameters and using calculated information to set oven parameter; or alternately, recalling a already determined set of calculated parameters and then setting the oven parameters. The latter is useful in the case where a kitchen often repeats the same cooking case.

The general form of the cooking time sub-algorithm is:

$$\begin{matrix}( cooking time , sec ) = & ( mass of the foodstuff , kg ) * \\ & ( specific foodstuff cooking energy , \\ & J \text{/} kg ) / \{ [ ( oven steam heat rate , \\ & J \text{/} kg sec ) + ( oven thermal heat rate , \\ & J \text{/} kg sec ) ] * ( mass of the foodstuff , kg ) + \\ & ( oven microwave heat rate , J \text{/} sec ) * \\ & ( fill factor ) \}\end{matrix} \qquad Eq . 2$$

The (heat rate) parameters in the (cooking time) sub-algorithm are to some degree dependent on the detail of oven design and the detail of the foodstuff class. The form of the thermal and steam (heat rate) sub-algorithm is:

$$\begin{matrix}( heat rate , J \text{/} kg sec ) = & ( area specific heat rate , J \text{/} m 2 ) * \\ & ( specific area of the foodstuff , m 2 \text{/} kg )\end{matrix} \qquad Eq . 3$$

The (area specific heat rate) will be oven design specific and should be determined for each design. The (specific area of the foodstuff) at first may appear to be a highly variable parameter but is not so for broad classes of food stuffs and because foodstuff size, shape, and weight, are already regulated as natural part of portion control in commercial kitchens. (Area specific heat rate) and the (specific area of the foodstuff) are available to the algorithm in look up tables as is the (oven microwave heat rate).

A (fill factor) term is included with the (oven microwave heat rate) term to deal with the case of small amounts of foodstuff that might be placed in the oven or with foodstuffs that are porous and accordingly have low thermal conductivity. A (fill factor) is advantageous for microwave energy because microwave energy is absorbed uniformly in all the water constrained in the oven; therefore it is possible, in some cases, to apply too much energy and over cook a particular foodstuff. The (fill factor) may be a look up value based on oven load and foodstuff and cooking cycle type.

The (specific foodstuff cooking energy) will be similar for broad classes of individual foodstuffs but will be dependent on the specific characteristics of the class. The general form of the (specific foodstuff cooking energy) sub-algorithm is:

$$\begin{matrix}( specific foodstuff & \{ ( final temperature of the foodstuff , \\ cooking energy , J \text{/} kg ) = & ° C . ) - ( initial temperature of the \\ & food stuff , ° C . ) \} * ( heat capacity \\ & of the food stuff , J \text{/} kg ° C . ) + \\ & ( water lost during cooking , kg ) * \\ & ( water latent heat of \\ & vaporization , J \text{/} kg ) - ( initial \\ & temperature of frozen foodstuff , ° C . ) * \\ & ( heat capacity of frozen food stuff , \\ & J \text{/} kg ° C . ) * ( mass of food stuff , kg ) + \\ & ( water latent heat of food stuff \\ & freezing , J \text{/} kg )\end{matrix} \qquad Eq . 4$$

At first it would appear that the heat capacity and latent heat parameters would have to be determined individually but this is not the case as the value for water alone can be used for this parameter since water is the major constituent of food and also since water has significantly higher heat capacity than any other material constituent of the foodstuff. Likewise, the initial temperature will be generally the same for any commercial kitchen. The final temperature is already established for example internal temperature for various meet colors or doneness are already established. In many cases the (specific foodstuff cooking energy) can be made available to the algorithm in a look up table but it also could be calculated for each individual case.

A close inspection of the above algorithms will show that they can be written in a different but equivalent form, e.g.

$$\begin{matrix}( cooking time ) = & ( mass of the foodstuff ) * \\ & ( specific foodstuff cooking energy ) / \\ & \{ [ ( steam heat rate ) + \\ & ( thermal heat rate ) ] * \\ & ( mass of the food stuff ) + \\ & ( microwave rate ) \}\end{matrix} \qquad Eq . 5$$

can be written as:

$$\begin{matrix}( cooking time ) = & ( specific foodstuff cooking energy ) / \\ & \{ [ ( steam heat rate ) + \\ & ( thermal heat rate ) ] + \\ & ( microwave rate ) / ( mass of the foodstuff ) \}\end{matrix} \qquad Eq . 6$$

In the first form, it is easier to understand that the available microwave energy is fixed, it is what it is. The microwave energy is distributed uniformly to the entire mass of foodstuff in the oven; with microwaves alone the cooking time is dependent on the amount of foodstuff in the oven. Also it is clear in this form that the total thermal and steam energy delivered by the oven varies with the amount of foodstuff in the oven.

In the second form it is easier to understand that for those algorithms that use thermal and/or steam energy alone, the time to cook is independent of the load as long as the capacity of the oven is not exceeded.

Detailed fundamental cooking time and humidity setting sub-algorithms or cycles for typical foodstuff groups and conditions are given below. The cycles given are the simplest form cycle and will give the shortest cooking times for a foodstuff class. In many practical cases it maybe desirable to break the basic cycle into two parts and chain the sub-cycles. In this case one or more parameters is changed from one step to the next in order to achieve a desired result or enhance a property of a cooked foodstuff. In such cases cooking time is often longer than the basic cycle. This penalty can be reduced in some cases by combining cycles (doing them in parallel), e.g. combining browning with roasting or thawing with cooking.

### Browning Cycle

(Browning time) for temperatures above about 175° C. is equal to 15−(T−260)*0.18 min. Humidity is set to a high but non-condensing level.

### Roast Cycle

Cooking time depends on the desired final internal temperature of the meat and thermal cooking temperature of the oven. From our analysis and empirical findings, the following table gives energy generally required for roasting meat starting at refrigerator temperature. The relative humidity is set to a high but non-condensing level to manage loss of moisture during roasting. Humidity setting ideally is as high a possible to avoid condensation at cooking temperature—typically humidity is set at a dew point in the range of about 95° C.

| Internal | Energy |
|---|---|
| Temperature ° C. | kJ/kg |
| 40 | 120 |
| 50 | 160 |
| 60 | 210 |
| 70 | 250 |
| 80 | 290 |
| 85 | 310 |

For roasting meat the (cooking time) is equal to:
(total mass of meat)*(specific foodstuff cooking energy)/{thermal heat transfer rate)*(mass of the meat)+(microwave heat rate)}.

For roasting at 175° C. to achieve a 60° C. internal temperature, rare, a typical oven load of 12 kg and a typical thermal heat transfer rate of 120 J/sec kg and microwave heat rate of 2000 J/sec, cooking time is 12*210000/{120*12+2000} or 729 sec which is 12 minutes. This is the shortest roasting time for this particular oven described. If it is desirable to achieve more uniform internal temperature throughout the roast (more uniform color), longer times must be used; a very satisfactory result can be achieved in 20 minutes by reducing the microwave power rate by one third. With these short-cooking times it is usually desirable to include a browning cycle. This can be done sequentially or in parallel with the cooking by increasing the cooking temperature to above 175° C.

This roasting cycle is appropriate for roasting fowl; the input parameters will necessarily be appropriate to fowl, e.g. higher final temperatures and resulting in longer cooking times.

### Thawing Cycle

The thawing cycle is intended to be chained as part of a cooking cycle, cooking frozen vegetables, but in some circumstances it can be used to return frozen foods to room temperature.

(Thaw time) is equal to:
(latent heat of freezing)*(mass of food)/{(microwave heating rate)*(fill factor)+[(steam heating rate)+(thermal heating rate)]*(mass of food)}.

For a typical case of 12, 1.25 kg, chickens this is equal to 336000*16/{2000*0.3+[140+60]*16} or 1415 sec. In this thaw example the (fill factor) term is explicitly shown since some foodstuffs have relatively low thermal conductivity and non-uniform temperature distributions can occur for low fill factors.

### Vegetable Cycle

Vegetable cycle uses condensing steam and thermal heat in addition to microwave power. (Cooking time) for fresh vegetables is equal to:
(mass of vegetables)*(specific foodstuff cooking energy)/{[(steam heat rate)+(thermal heat rate)]*(mass of the vegetables)+(Microwave rate)}.

For a typical case of a load 9 kg of green beans, a high surface area per kg porous vegetable, the (cooking time) is 9*165000/(420+60)*9+2000 or 424 sec. For a low surface area per kilogram dense vegetable, potatoes, the (cooking time) is 9*336000/(140+60)+2000 or 796 sec. Notice in these examples that the high surface area of some vegetables influences the heating rate terms.

### Baking Cycle

Humidity level is set to the lowest value; the oven is vented. One of the primary processes in baking is reduction of moisture. (Cooking time) for baking is equal to:
(mass of the foodstuff)*(specific foodstuff cooking energy)/{(thermal heat rate)*mass of the product+microwave heat rate)}.

For a typical case of 90 croissants (9 kg) cooking time is 9*150000/{120*9+2000} or 438 sec.

### Shock Cycle

Many foods are thermally shocked to quickly heat the direct foodstuff surface as a first step in cooking. Bread is a typical example where condensing steam alone is injected into the oven to quickly cook the surface. Shock time is equal to 10 sec of condensing steam.

### ReTherm or ReGeneration or Reheating

Many foods are prepared beforehand to an almost cooked or fully cooked condition well before service and then reheated at service time. This is typically done at banquet halls or in eateries that must serve a lot of plates in a very short time. The relative humidity is set to a high non-condensing dew point typically 95 C. (Reheating time) is equal to:
the (mass of the foodstuff)*(specific reheat time)/{[(steam heat rate)+(thermal heat rate)]*(mass of the foodstuff)+(Microwave rate)*(fill factor)}.

For a typical case the reheating time is =9*165000/{(140+60)*9+2000*0.3} or 648 sec.

The algorithms have been generalized for broad classes of food but it is within our approach to allow specific cooking energy and heating rates for more narrowly defined classes of foodstuffs. In fact, the parameters can be refined to individual foodstuffs if so desired. Additionally it may be desirable to combine processes in the same cooking cycle. For example, the thaw algorithm and the porous vegetable or the browning with the roasting algorithm or yet again for some vegetables it might be desirable to combine the porous cycle with the dense algorithm one following the other.

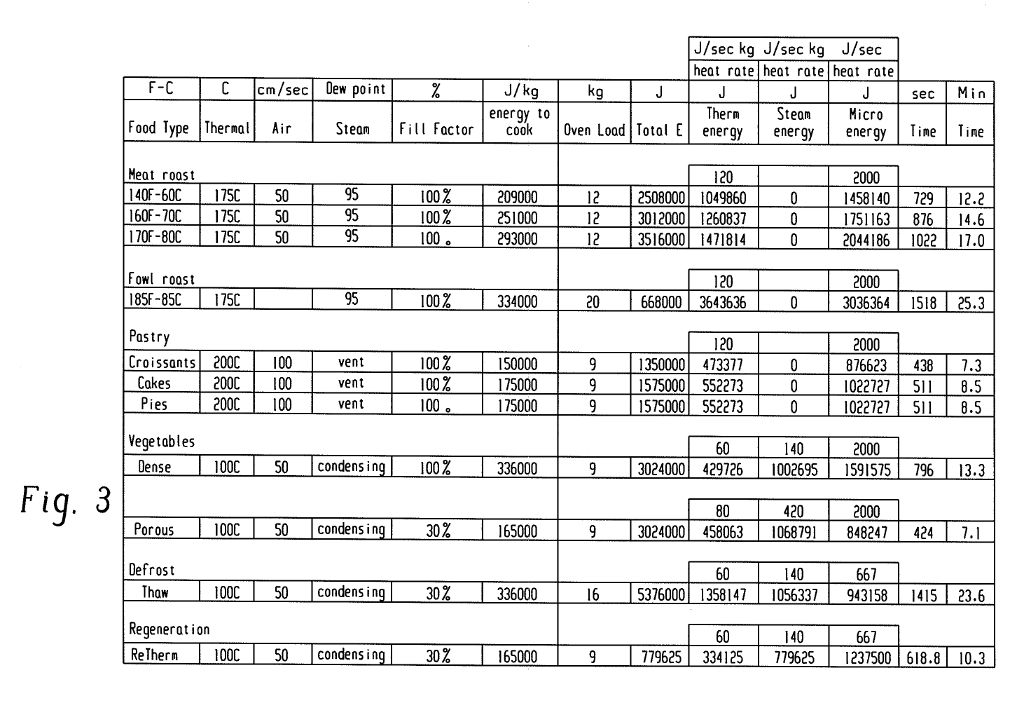

The table of FIG. 3 summarizes the algorithms for typical cases.

### Automated Control

The above algorithms may be incorporated into an oven control system, which can include a microprocessor, sequential process controller or other controller. The oven may include a graphical user interface having a means to identify the food type, for example using words or icons; a means to enter foodstuff mass; a means to include food condition, for example rare or well done; and a means to permit deviations from the preset conditions for example more or less done, that allow a chef to compensate for alternative cooking utensils, regional style and expectation or other variants.

The controller may allow provision for cook and hold and delayed start options.

The algorithms can be used to convert foodstuff-cooking cycles already developed by a chef for older convection ovens and steam convection combination ovens to new cycles that take advantage of all three energy sources of triple combination ovens.

The control system has the capacity to store look up tables as well as a multiple of cooking cycles.

We envision the possibility of being able to add parameters, cooking cycles and classes of foodstuffs or to modify existing parameter tables and cooking cycles. We also anticipate the capability to manually enter a cooking cycle in terms of basic oven parameters such as temperatures, times, dew point and fill factor etc.

The control system interfaces with fundamental oven functions to control all oven functions to achieve the desired cooking results.

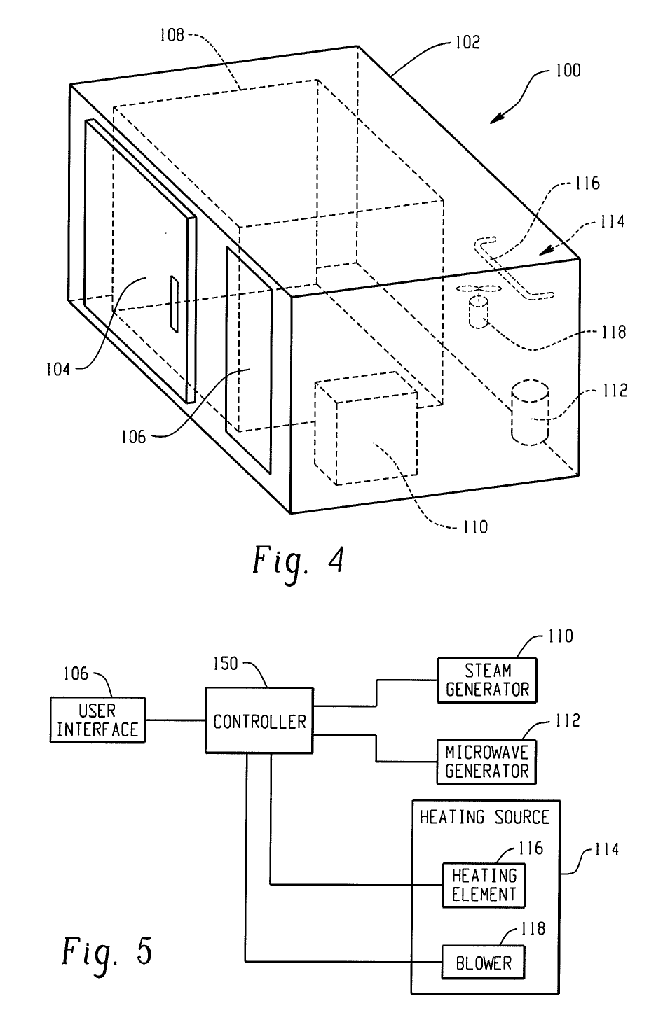

Referring to FIG. 4, a schematic depiction of a basic oven construction 100 is shown including an external housing 102, oven door 104 and control panel 106. Internal to the housing a cooking cavity 108 is defined. The oven includes an associated steam generator (e.g., an electric or gas boiler) 110 plumbed for controlled delivery of steam to the cavity 108. The steam generator 110 may be incorporated within the primary housing 102 as shown, or could be a separate unit connected with the primary housing 102. A microwave generator 112 produces microwave radiation that is delivered to the oven cavity 108 via a suitable path as may be defined utilizing waveguides. A convection heating source 114 may be formed by an electric or gaseous heating element 116 in association with one or more blowers 118, with suitable delivery and return airflow paths to and from the cavity 108. The exact configuration of the oven could vary.

A basic control schematic for the oven 100 is shown in FIG. 5, utilizing a controller 150 in association with the user interface 106, steam generator 110, microwave generator 112, and convection heating source 114. The controller 150 can be programmed in accordance with the algorithms and methodologies as described above.

Utilizing the above algorithms and related assumptions, a variety of advantages methods and systems can be implemented in the context of triple combination ovens using convection, steam and microwave as will now be described in further detail.

### Consistent Duration Cooking Cycles For Different Food Product Masses

In commercial kitchens there exists a desire for consistency in food product as well as consistency in preparation time. For a standard combination oven using only steam and convection, cooking time is not impacted by the mass of food product placed in the oven, provided the oven capacity is not exceeded. However, as mentioned above, cooking time using microwave energy is impacted by the mass of food product being cooked. It would be desirable to provide a triple combination oven that accounts for such a factor.

A method of cooking a food product using a combination oven including a microwave source for cooking and at least one non-microwave cooking source is provided. The oven including a user selectable cooking program for the food product (e.g., selectable via the interface 106 of FIGS. 4 and 5). A cooking operation implemented by the user selectable cooking program utilizes both the microwave source and the non-microwave source (e.g., steam or convection, or both steam and convection). The method involves identifying a food product mass value that does not exceed capacity of the oven for the food product to be cooked during operation of the cooking program; carrying out the cooking operation according to the user selectable cooking program, including: utilizing the food product mass value to set microwave energy applied to the food product during operation of the cooking program such that cook time remains constant regardless of food product mass while achieving end product with a comparable degree of doneness.

In one embodiment a first step in initiating a combination oven cooking program would be the operator pressing an interface button (or displayed graphical icon) that selects a cooking program for a specific food product type. By way of example, an operator presses a button with a chicken icon for initiating the chicken cooking program, presses a button with a vegetable icon to initiate a vegetable cooking program, or presses a button with a roast icon to initiate a roast cooking program. As another example, different cooking programs may be given different numbers and the operator will refer to a chart (or his/her memory) that associates cooking program numbers with cooking program types.

The step of identifying a food product mass value could involve having a user enter a specific, known weight of the food product (e.g., 1 kg). Alternatively, a user could select from a range of weights displayed to the user (e.g., a mass range indicator). In another example, a user could enter a number of items of the food product being placed in the oven (e.g., 10 chicken breasts) where a weight or mass for each item is assumed to be relatively constant given consistency of portion size in commercial kitchens. Thus, food product mass value can be any value that is indicative of the mass of the food product.

By way of example, if the food product being cooked happens to be chicken, a commercial kitchen may be organized such that the chef desires cooking of the chicken to consistently be completed in 15 minutes. In such a circumstance, if 2 kg. of chicken is being cooked the microwave energy level may be set at, for example, 60% to achieve a 15 minute cooking time for a specific chicken cooking program. On the other hand, to achieve the same 15 minute cooking time if 1 kg. of chicken is being cooked, the microwave energy may be set at 40% for the same chicken cooking program. Thus, as a general rule applied microwave energy is increase for greater food product mass. Equation 5 or 6 above can be used by the oven control to make the appropriate adjustment to applied microwave energy level by solving for the “microwave rate” parameter. Applied microwave energy is typically set by controlling the on time of at least one microwave generator (e.g., 60% on time or 40% on time as may be determined by the duty cycle of a microwave control signal). As a general rule, the non-microwave source will be operated at a level (e.g., convection temperature level) that is independent of the identified food product mass value.

Thus the method above provides a combination oven using microwaves, where the oven automatically takes into account food product mass to achieve end product with a comparable degree of doneness in a consistent cooking time. This feature enables a relatively unskilled operator (i.e., someone that is not a chef) to produce a consistent food product that will meet the desires of the chef that is running the kitchen while at the same time maintaining a consistent cook time.

The degree of doneness can be evaluated based upon one or more factors dependent upon the type of food product. For example, for red meats, the degree of doneness may be determined on a scale of rare, medium rare, medium, medium well and well, or on a temperature scale. As another example, for meats it is also common to determine doneness as a function of meat temperature and brownness. For vegetables doneness may be evaluate based upon firmness and/or texture. Terminology for doneness in association with vegetables is exemplified by “bite”, “al dente” or “very soft”. For baked goods degree of doneness may be a function of brownness and/or moisture level.

### Conversion of Non-Microwave Cooking Programs to Microwave-Enhanced Cooking Programs

As previously mentioned, with the introduction of a triple combination oven (i.e., convection, steam and microwave) to the market that has traditionally used double combination ovens (i.e., convection and steam), difficulty can be created for users in defining new cooking programs. It would be desirable to facilitate such conversions for the oven users. In one example such a conversion feature could be integrated into the oven control. In another example such a conversion feature could be provided as a program run by a separate computerized device.

### Integrated Conversion

A method of using a combination oven that includes a microwave source for cooking, a steam source for cooking and a convection source for cooking is provided where the oven including a control for controlling cooking operations. The method involves: the control receiving a non-microwave cooking program for a food product, the non-microwave cooking program utilizing at least one of steam or convection; the control automatically converting the non-microwave cooking program to a microwave enhanced cooking program that uses microwaves in addition to at least one of steam or convection; and the control storing the microwave enhanced cooking program for later selection and use.

The control may receive the non-microwave cooking program via user input at the interface 106 of FIGS. 4 and 5. Alternatively, the controller 150 may include a communications link (e.g., hard-wired or wireless) by which the non-microwave cooking program is uploaded.

The conversion may be achieved by the control using algorithms and/or look-up tables that rely upon the above theory. Specifically, Eq. 4 above can be used to determine the specific foodstuff cooking energy delivered to the food product by the non-microwave program, using predefined heat rates for the steam or convection, which rates may be determined for the oven associated with the non-microwave program (e.g., in which case the user may also identify to the control the specific oven used to carry out the non-microwave program). Eq. 5 or 6 above can then be used to calculate a total cooking time for the microwave enhanced cooking program as necessary to achieve substantially the same applied cooking energy. In this regard, microwave rate (i.e., microwave energy level) may be selected at a rate that is previously determined to be acceptable for the specific food product. By way of example, higher microwave rates may be more acceptable for vegetables than for meats. Thus, the automated conversion may not always result in the fastest cooking time for the microwave enhanced program. Rather, the automated conversion may produce a microwave-enhanced cooking program that is faster than the non-microwave enhanced cooking program, but still produces a high quality food product.

### Assisted Conversion

A similar method can be carried out with the aid of a device separate from the oven control. Specifically, such a method would involve uploading a non-microwave cooking program for a food product to a computer device separate from the combination oven, the non-microwave cooking program utilizing at least one of steam or convection; the computer device automatically converting the non-microwave cooking program to a microwave enhanced cooking program that uses microwaves in addition to at least one of steam or convection; transmitting the microwave enhanced cooking program from the computer device to the control of the combination oven; and storing the microwave enhanced cooking program in the control of the combination oven for later selection and use.

As with the prior method, the conversion can be made using algorithms and/or look-up tables running on the computerized device. The computerized device could be personal computer, hand-held computer device or other computer device. The uploading to the computerized device could be achieved electronically, via manual input or via a combination of the two. The transmitting may be achieved via a hard-wired connection between the combination oven control and the computer device, via wireless transmission from the computer device to the combination oven control, or via a combination of the two. It is also contemplated that a web site could be established by which oven purchasers could log on, upload or otherwise input non-microwave programs and have microwave enhanced programs delivered back for uploading to the triple combination oven.

### Power Sharing among Cooking Sources

Another issue that can arise in combination ovens is the need to factor in power limitations. Specifically, a given combination oven may have a power source with a rated available power that is less than the total power that might be called for when multiple cooking sources are being operated simultaneously. This presents the question of how to modify cooking operations to account for the inability to apply the power to each cooking source that might be called for by a cooking program.

In this regard, a method of controlling power sharing in a combination oven is provided. The oven includes each of a convection heat cooking source, a steam cooking source and a microwave energy cooking source. A collective power consumption capability of the convection heat cooking source, steam cooking source and microwave energy cooking source is higher than rated power available from a power source of the combination oven. The method involves the steps of: (a) if individual power called for from any one of the cooking sources needed to cook a mass of food product according to a cooking program is greater than the power capacity of the cooking source, utilize the power capacity of such cooking source to evaluate any need for power sharing; and (b) if total power needed to cook the mass of food product using multiple cooking sources simultaneously in accordance with the cooking program, taking into account any adjustments per step (a), exceeds the rated power available from the power source, reduce the power to be delivered to the cooking source that has the lowest specific power absorption rate to the food product until total power demand of the multiple cooking sources is equal to or below the rated power available from the power source.

Step (a) is the application of a fairly simple rule, namely that if a cooking program calls for more power from a given cooking source than the given cooking source is capable of delivering, the best that can be done is to default that cooking source to its highest available power (i.e., its power capacity). For example, if a cooking program calls for 24.0 kW of power from a convection source having a capacity of 18 kW, then the convection source is defaulted to the 18 kW level for the purpose of assumed oven operation and power sharing analysis. The power called for from a steam or convection cooking source can be determined by considering the power absorption rate for the food product for a determined or assumed surface area of the food product. By way of example, chicken breasts or peas or beans may be assumed to have a specific surface area that will result in a specific corresponding power absorption rate (e.g., J/sec-kg). By multiplying that power absorption rate by the identified mass of the food product to be cooked, the total power called for from the cooking source can be determined and evaluated to see if it exceeds the power capacity of such source. For a microwave source, the power absorption rate will in fact vary by food product mass and, as a general rule the power called for from the microwave source will not exceed its power capacity.

Step (b) implements a rule intended to provide a result that reduces, to the extent possible, the additional cooking time that will be required due to the inability to meet the energy levels called for from the cooking sources according to the cooking program (i.e., total power called for exceeds rated power of the power source). This result is achieved by reducing the power to be delivered to the cooking source that is delivering the least amount of energy to the food product, i.e., the cooking source with the lowest specific power absorption rate to the food product. Specific power absorption rates for each cooking source may be evaluated based upon preset absorption efficiency values for each cooking source. In many applications the convection cooking source will have the lowest specific power absorption rate, followed by the steam cooking source, followed by the microwave cooking source (depending upon mass). In a particular case where each of convection, microwave and steam are being used, such as when cooking a roast and there the steam source is operated for short periods of time to maintain humidity in the oven while convection and microwave cooking are also operating, it may be desirable to give some preference to the steam cooking source. For example, the need and manner of power sharing could be evaluated based on convection and microwave only, but the oven control could be set up to temporarily disable either the convection source or the microwave source when there is a need to turn on the steam source for a short period of time. Alternatively, the steam source could be included in the analysis of the need for power sharing, but with the steam source never being the source for which power is reduced. As another alternative, the oven control could operate to only deliver power to the steam source during down time of one of the other sources (e.g.,

However, food quality issues should preferably be taken into account when following the rule or step (b). One manner of doing so is to also utilize one or more established cooking source power ratio limits (e.g., the ratio power to be delivered by microwave energy to power to be delivered by convection power). For example, when cooking chicken if the power delivered by microwave is too high as compared to convection, the texture of the chicken may be adversely affected. By monitoring such cooking source power ratio limits, if step (b) results in the violation of such a ratio limit, the power to be delivered to both cooking sources associated with the cooking source power ratio limit can be reduced (i) until total power demand of the multiple cooking sources is equal to or below the rated power available from the power source and (ii) in a manner to prevent violation of the cooking source power ratio limit.

### Automated Estimation of Additional Cooking Time Needed

In cases where a cooking program calls for more power than a given cooking source can deliver, or where power sharing amongst multiple cooking sources operating simultaneously becomes necessary, additional cooking time will be needed to achieve an end product of comparable doneness. In this regard, a method is provided for controlling a cooking operation in a combination oven that includes each of a convection heat cooking source, a steam cooking source and a microwave energy cooking source, where a collective power consumption of the convection heat cooking source, steam cooking source and microwave energy cooking source is higher than rated power available from a power source of the combination oven. The method involves the step of: if individual power called for from any one of the cooking sources needed to cook a mass of food product according to a cooking program having a set cooking time is greater than the power capacity of the cooking source, utilize the power capacity of such cooking source to determine an extended cooking time needed. The extended cooking time can be determined using Eq. 2 above. The oven control may also operate to automatically adjust a cooking clock for the cooking program to reflect the extended cooking time (e.g., rather than a timer for the cooking program running for 6 minutes it might run for 6 minutes and 30 seconds).

It is to be clearly understood that the above description is intended by way of illustration and example only and is not intended to be taken by way of limitation. Variations are possible.

What is claimed is:

1. A method of cooking a food product using a combination oven including a microwave source for cooking and at least one non-microwave cooking source, the oven including a user selectable cooking program for the food product, a cooking operation implemented by the user selectable cooking program utilizing both the microwave source and the non-microwave source, the method comprising:
identifying a food product mass value that does not exceed capacity of the oven for the food product to be cooked during operation of the cooking program; and
carrying out the cooking operation according to the user selectable cooking program, including:
utilizing the food product mass value to set microwave energy level applied to the food product during operation of the cooking program and without changing cook time as set by the cooking program.

2. The method of claim 1 wherein the microwave energy level is set such that end product achieved without changing cook time has a comparable degree of doneness regardless of mass.

3. The method of claim 1, wherein carrying out the cooking operation further includes:
operating the non-microwave source at a level independent of the identified food product mass value.

4. The method of claim 1 wherein the food product mass value is one of a specific mass or a mass range indicator.

5. The method of claim 1 wherein the microwave energy level is set such that the lower microwave energy levels are applied for lower masses of food product.

6. The method of claim 1 wherein applied microwave energy level is set by controlling the on time of at least one microwave generator.

7. The method of claim 6 wherein applied microwave energy level is set by controlling a duty cycle of the microwave generator.

8. A method of using a combination oven that includes a microwave source for cooking, a steam source for cooking and a convection source for cooking, the oven including a control for controlling cooking operations, the method comprising:
the control receiving a non-microwave cooking program for a food product, the non-microwave cooking program utilizing at least one of steam or convection;
the control automatically converting the non-microwave cooking program to a microwave enhanced cooking program that uses microwaves in addition to at least one of steam or convection;
the control storing the microwave enhanced cooking program for later selection and use.

9. The method of claim 8 wherein the automatic conversion is made utilizing an algorithm implemented by the control.

10. The method of claim 8 wherein the automatic conversion is made using a look-up table accessed by the control.

11. The method of claim 8 wherein the automatic conversion is made using predefined heat rates for the steam or convection.

12. The method of claim 8 wherein the automatic conversion is made by the control:
determining a cooking energy applied to the food product via the non-microwave cooking program;
calculating a total cooking time for the microwave enhanced cooking program as necessary to achieve substantially the same applied cooking energy.

13. A method of setting up a combination oven that includes a microwave source for cooking, a steam source for cooking and a convection source for cooking, the oven including a control for controlling cooking operations, the method comprising:
uploading a non-microwave cooking program for a food product to a computer device separate from the combination oven, the non-microwave cooking program utilizing at least one of steam or convection;
the computer device automatically converting the non-microwave cooking program to a microwave enhanced cooking program that uses microwaves in addition to at least one of steam or convection;
transmitting the microwave enhanced cooking program from the computer device to the control of the combination oven; and
storing the microwave enhanced cooking program in the control of the combination oven for later selection and use.

14. The method of claim 13 wherein the automatic conversion is made utilizing an algorithm implemented by the computer device.

15. The method of claim 13 wherein the automatic conversion is made using a look-up table accessed by the computer device.

16. The method of claim 13 wherein the automatic conversion is made using predefined heat rates for the steam or convection.

17. The method of claim 13 wherein the automatic conversion is made by the computer device:
determining a cooking energy applied to the food product via the non-microwave cooking program;
calculating a total cooking time for the microwave enhanced cooking program as necessary to achieve substantially the same applied cooking energy.

18. The method of claim 13 wherein the uploading is achieved electronically, the uploading is achieved via manual input or the uploading is achieved via a combination of the two.

19. The method of claim 13 wherein the transmitting is achieved via a hard-wired connection between the combination oven control and the computer device, the transmitting is achieved via wireless transmission from the computer device to the combination oven control, or the transmitting is achieved via a combination of the two.

20. A method of controlling power sharing in a combination oven that includes each of a convection heat cooking source, a steam cooking source and a microwave energy cooking source, a collective power consumption capability of the convection heat cooking source, steam cooking source and microwave energy cooking source being higher than rated power available from a power source of the combination oven, the method comprising the steps of:
(a) if individual power called for from any one of the cooking sources needed to cook a mass of food product according to a cooking program is greater than the power capacity of the cooking source, utilize the power capacity of such cooking source to evaluate any need for power sharing; and
(b) if total power needed to cook the mass of food product using multiple cooking sources simultaneously in accordance with the cooking program, taking into account any adjustments per step (a), exceeds the rated power available from the power source, reduce the power to be delivered to the cooking source that has the lowest specific power absorption rate to the food product until total power demand of the multiple cooking sources is equal to or below the rated power available from the power source.

21. The method of claim 20, comprising the further step of:
(c) if the reduction called for in step (b) results in violation of an established cooking source power ratio limit, reducing the power to be delivered to both cooking sources associated with the cooking source power ratio limit (i) until total power demand of the multiple cooking sources is equal to or below the rated power available from the power source and (ii) in a manner to maintain the cooking source power ratio limit.

22. The method of claim 20 wherein specific power absorption rates for each cooking source are evaluated based upon preset absorption efficiency values for each cooking source.

23. A method of controlling a cooking operation in a combination oven that includes each of a convection heat cooking source, a steam cooking source and a microwave energy cooking source, a collective power consumption capability of the convection heat cooking source, steam cooking source and microwave energy cooking source being higher than rated power available from a power source of the combination oven, the method comprising the steps of:
if individual power called for from any one of the cooking sources needed to cook a mass of food product according to a cooking program having a set cooking time is greater than the power capacity of the cooking source, utilize the power capacity of such cooking source to determine an extended cooking time needed.

24. The method of claim 23 wherein a cooking clock for the cooking program is automatically adjusted to reflect the extended cooking time.
